(19) United States
(12) Patent Application Publication
(10) Pub. No.: US 2013/0056976 A1
(43) Pub. Date: Mar. 7, 2013

(54) ONE-TOUCH PIPE CONNECTION DEVICE

(71) Applicant: Sung-Hun Kim, Hwasung-si (KR)

(72) Inventor: Sung-Hun Kim, Hwasung-si (KR)

(21) Appl. No.: 13/356,641

(22) Filed: Jan. 23, 2012

(30) Foreign Application Priority Data
Sep. 2, 2011 (KR) 10-2011-0089164
Nov. 7, 2011 (KR) 10-2011-0115035
Dec. 22, 2011 (KR) 10-2011-0140244

(51) Int. Cl. F16L 27/12

(52) U.S. Cl. 285/32

(57) ABSTRACT

A one-touch pipe connection device includes a body member for receiving a pipe, a fluid-tight member positioned in each of left and right side of the inner peripheral surface of the first body member with reference to the longitudinal center of the inner peripheral surface to ensure fluid-tightness, a support member for linearly compressing the fluid-tight member, a fastening member being screwed to the body member; a compression member inserted into the fastening member, and moved outwardly by a compression spring, and a plurality of tight contact elements provided on the compression member tightly clamped on the outer peripheral surface of the pipe when the compression member is moved.

### PRIORITY

The present application claims priority under 35 U.S.C. §119(a) to Korean Patent Application No. 10-2011-0089164, filed in the Korean Intellectual Property Office on Sep. 2, 2011, to Korean Patent Application No. 10-2011-0115035, filed in the Korean Intellectual Property Office on Nov. 7, 2011, and to Korean Patent Application No. 10-2011-0140244, filed in the Korean Intellectual Property Office on Dec. 22, 2011, the disclosures of which are hereby incorporated by reference in their entireties.

### BACKGROUND OF THE INVENTION

1. Field of the Invention

The present invention relates to a one-touch type pipe connection device, and more particularly to a one-touch pipe connection device, which ensures excellent fluid-tightness, excellent clamping force, and convenient assembly while allowing pipe-to-pipe connection to be conducted simply.

2. Description of the Prior Art

As generally known in the art, pipes and pipe joints with various sizes and shapes are used for guiding fluids to one or more predetermined courses, and pipe connection methods using such pipes and pipe joints in combination employs a welding process that may provide endurance and fluid-tightness at connected parts.

However, such a welding process requires enough space for welding work for connecting pipes, and repair work is very inconvenient to conduct when defects occur at the welded parts even after connecting pipes through welding. For example, since welding areas should be formed along the outer peripheral surfaces of the pipes, if pipe-to-pipe connection is conducted through welding, it is essential to secure a work space large enough to perform the welding work. In addition, if it is necessary to interpose or reinstall one or more pressure wheels between pipes subsequently at the time of defect-repairing as the pressure wheels are used when connecting the pipes through welding, it is very difficult to interpose or reinstall the pressure wheels between the pipes. Moreover, if pipes with different sizes are connected through flange-coupling, welding or the like, additional expensive pipe joints are required. To solve these problems, the inventor of the present application developed pipe connection devices as disclosed in Korean registered patent Nos. 10-0899461 and 10-0927198.

However, the pipe connection devices of the above-mentioned patents have a problem in that since the pipe connection devices are to be clamped to pipes by tightening using a plurality of externally exposed bolts, it is impossible to ensure fluid-tightness and clamping force if and when an impact is applied to the bolts so that the bolts are loosened. In addition, it is essential to firmly fasten the bolts, and the work can be difficult, less efficient, and time-consuming. In order to solve these problems, the inventor developed a pipe connection device as disclosed in Korean registered patent No. 10-0977308. However, researches for saving materials by reducing a size of a product as well as for ensuring better fluid-tightness, and for convenient assembly are required.

### SUMMARY OF THE INVENTION

Disclosed herein is a one-touch pipe connection device. The one-touch pipe connection device includes features for ensuring reduction in size and convenient assembly of the final products as well as more excellent fluid-tightness and clamping force, while avoiding a structure anchored by one or more bolts and allowing simple pipe-to-pipe connection.

The one-touch pipe connection device includes a first body member with a size for receiving a pipe, and the first body member includes, on each of the left and the right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the insertion groove, the stepped portion, the first insertion groove and the threaded portion are arranged in this order from the longitudinal center to each end of the inner peripheral surface of the first body member; a first fluid-tight member including a compression ring portion arranged along the first insertion groove, a seating portion integrally extending from the compression ring portion and arranged in the stepped portion, and an elastic portion slantingly extending from an end of the seating portion toward the center of the first body member so that the elastic portion comes into tight contact with a pipe along the outer peripheral surface of the pipe when the pipe is inserted; an annular support member formed with a compression groove that comes into tight contact with the compression ring portion; a fastening member which is adapted to compress one of the support members by one end thereof by being screwed to the first body member, the fastening member has a slanted surface with an inner diameter increasing along the direction of inserting the pipe, and a stopper portion formed at the smaller-diameter end of the slanted surface; a compression member including a first protrusion rib inserted into the fastening member to form a closed space for arranging a compression spring together with the stopper portion, and a second protrusion rib formed opposite to the first protrusion rib and exposed to the outside; and a plurality of tight contact elements installed at regular intervals on an end portion of the compression member positioned within the slanted surface, each of the tight contact elements having teeth, whereby when the pipe is inserted into the first body member, the teeth come into tight contact with the outer peripheral surface of the pipe with the help of the restoring force of the compression spring.

In accordance with another aspect of the present invention, a one-touch pipe connection device includes a second body member with a size for receiving a pipe, and the second body member has an anchoring protrusion formed along the inner peripheral surface of the second body member at the longitudinal center of the second body member, the inner peripheral surface being formed with threads on each end area thereof; an insertion member inserted into the second body member and fixed along the anchoring protrusion at the longitudinal central area thereof, and the insertion member has a second insertion groove at each end of the inner peripheral surface thereof; a second fluid-tight member including a fixed ring portion fixedly fitted in the second insertion groove, and an elastic portion slantingly extending from an end of the fixed ring portion toward the center of the second body member so that the elastic portion comes into tight contact with a pipe along the outer peripheral surface of the pipe when the pipe is inserted; a fastening member adapted to compress the insertion member by one end thereof by being screwed to the second body member, and the fastening member has a slanted surface with an inner diameter increasing along the direction of inserting a pipe, and a stopper portion formed at the smaller-diameter end of the slanted surface; a compression member including a first protrusion rib inserted into the fastening member to form a closed space for arranging a compression spring together with the stopper portion, and a second protrusion rib formed opposite to the first protrusion rib and exposed to the outside; and a plurality of tight contact elements installed at regular intervals on an end portion of the compression member positioned within the slanted surface, each of the tight contact elements has a teeth, whereby when the pipe is inserted into the first body member, the teeth comes into tight contact with the outer peripheral surface of the pipe with the help of the restoring force of the compression spring.

In accordance with still another aspect of the present invention, a one-touch pipe connection device includes a first body member with a size for receiving a pipe, and the first body member includes, on each of the left and the right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the insertion groove, the stepped portion, the first insertion groove and the threaded portion are arranged in this order from the longitudinal center to each end of the inner peripheral surface of the first body member; a first fluid-tight member including a compression ring portion arranged along the first insertion groove, a seating portion integrally extending from the compression ring portion and arranged in the stepped portion, and an elastic portion slantingly extending from an end of the seating portion toward the center of the first body member so that the elastic portion comes into tight contact with a pipe along the outer peripheral surface of the pipe when the pipe is inserted; an annular support member formed with a compression groove that comes into tight contact with the compression ring portion; a fastening member which is adapted to compress one of the support members by one end thereof by being screwed to the first body member, the fastening member has a slanted surface with an inner diameter increasing along the direction of inserting the pipe, and a stopper portion formed at the smaller-diameter end of the slanted surface; a push member having a second protrusion rib provided at an outer end thereof to be exposed to the outside, the push member is adapted to allow a compression spring to be arranged between the second protrusion rib and the end of the fastening member or the stopper portion, and the push member is partially inserted into the fastening member; and a plurality of tight contact elements installed at regular intervals on an end portion of the compression member positioned within the slanted surface, each of the tight contact elements having teeth, whereby when the pipe is inserted into the first body member, the teeth come into tight contact with the outer peripheral surface of the pipe with the help of the restoring force of the compression spring, the push member is formed with a plurality of slits spaced apart from each other and extends longitudinally from the end opposite to the second protrusion rib.

In accordance with yet another aspect of the present invention, a one-touch pipe connection device includes a body member having an inner peripheral surface, and the body member includes, on each of left and right sides of the inner peripheral surface with reference to the longitudinal center of the inner peripheral surface, a recessed portion formed by recessing the inner peripheral surface, a slanted surface with an inner diameter increasing along the direction of inserting a pipe, and a stopper portion formed at the smaller-diameter end of the slanted surface; an annular packing member which is introduced into the body member by being deformed by an external force, and then comes into tight contact with the inside of the recessed portion; a push member having a second protrusion rib provided at the outer end thereof to be exposed to the outside, and the push member is adapted to allow a compression spring to be arranged between the second protrusion rib and the end of the fastening member or the stopper portion, and the push member being partially inserted into the fastening member; and a plurality of tight contact elements installed at regular intervals on the end portion of the compression member positioned within the slanted surface, each of the tight contact elements has a teeth, whereby when the pipe is inserted into the first body member, the teeth come into tight contact with the outer peripheral surface of the pipe with the help of the restoring force of the compression spring, and the push members is formed with a plurality of slits spaced apart from each other and extends longitudinally from the end opposite to the second protrusion rib.

The one-touch pipe connection devices as described above enable firm pipe-to-pipe connection merely through a simple step of inserting a pipe into the one-touch pipe connection device, and are capable of providing more excellent fluid-tightness and reduction in size of the pipe connection device and connected pipes. As a result, the one-touch pipe connection devices may significantly shorten the time for installing, maintaining and repairing pipes, and may prevent accidents causing leakage beforehand, and can miniaturize the pipe connection device.

In addition, since each of the components of the one-touch pipe connection device can be made via an injection-molding process, a synthetic resin material as well as a metallic material can be used as a material for the one-touch pipe connection device, and thus, it is possible to mass-produce the one-touch pipe connection device with low manufacturing costs.

### BRIEF DESCRIPTION OF THE DRAWINGS

Features of the present invention will become apparent to those skilled in the art from the following description with reference to the figures, in which:

FIGS. 1 to 3 show a one-touch pipe connection device, according to an embodiment of the invention;

FIGS. 4 and 5 show a one-touch pipe connection device, according to another embodiment of the invention;

FIGS. 6 and 7 are cross-sectional views showing engagement constructions between a compression member and tight contact elements in a one-touch pipe connection device, according to an embodiment of the invention;

FIG. 8 shows a construction in which a cover part is applied to the one-touch pipe connection device, according to an embodiment of the invention;

FIG. 9 shows a construction for fixing the one-touch pipe connection device to an elastic bracket, according to an embodiment of the invention;

FIG. 10 shows a one-touch pipe connection device, according to an embodiment of the invention;

FIGS. 11 to 14 show examples of different modifications of a one-touch pipe connection device, according to an embodiment of the invention;

FIG. 15 shows a one-touch pipe connection device, according to an embodiment of the invention;

FIG. 16 shows a construction of a tight contact element clamped by a rubber band in the one-touch pipe connection device, according to an embodiment of the invention;

FIG. 17 illustrates a perspective view showing a construction in which a bracket is installed to a one-touch pipe connection device, according to an embodiment of the invention;

FIGS. 18 to 20 show that a disengagement prevention feature is applied between a push member and a fastening member in a one-touch pipe connection device, according to an embodiment of the invention; and

FIGS. 21 and 22 show variations of a one-touch pipe connection device, according to an embodiment of the invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments.

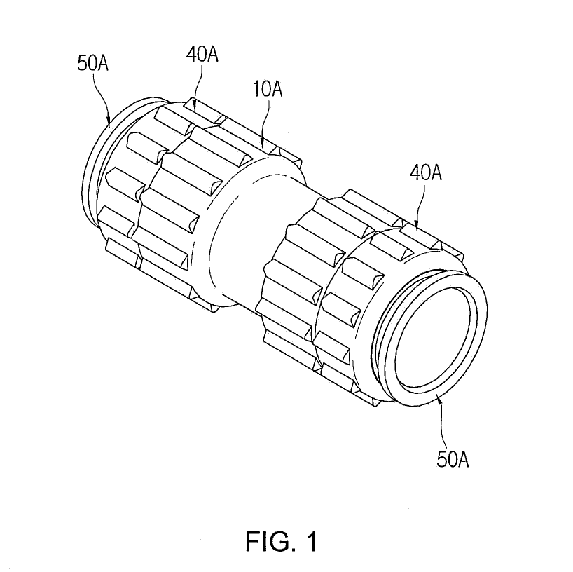

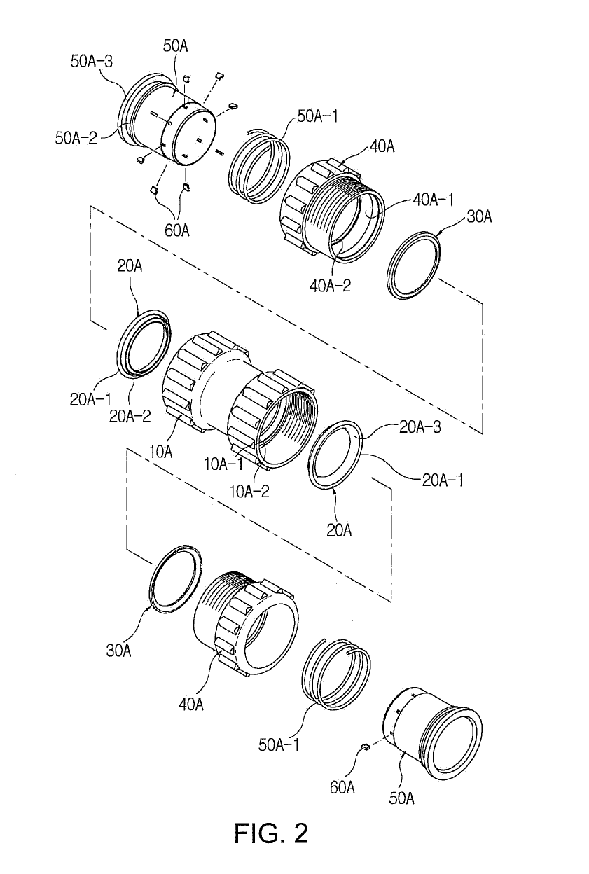

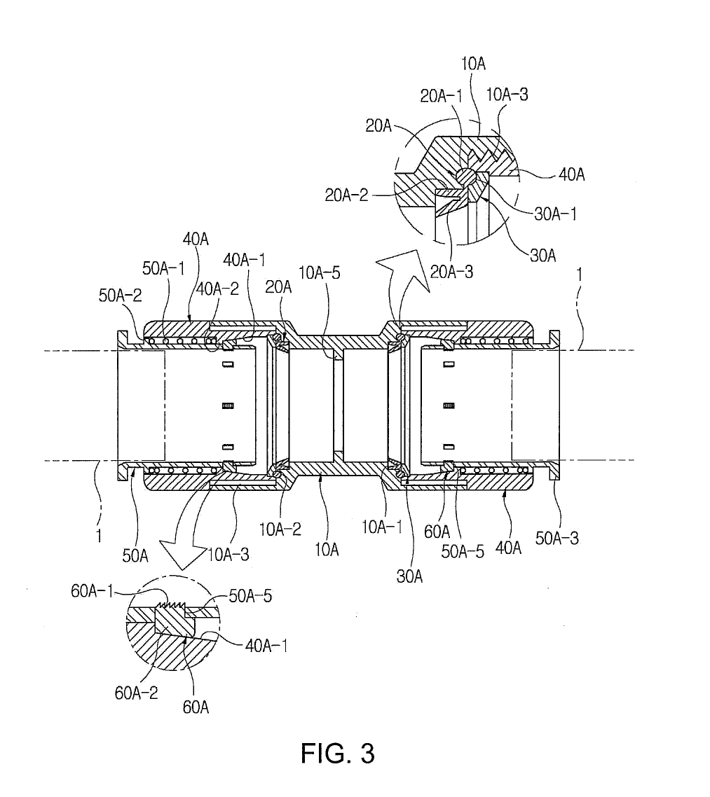

FIGS. 1 to 3 show a one-touch pipe connection device, according to an embodiment of the invention.

The one-touch pipe connection device includes a first body member 10A for receiving a pipe 1, a first fluid-tight member 20A positioned in each of left and right side of the inner peripheral surface of the first body member 10A with reference to the longitudinal center of the inner peripheral surface of the first body member 10A to ensure fluid-tightness, a support member 30A for linearly compressing the fluid-tight member 20A, a fastening member 40A screwed to the first body member 10A, a compression member 50A inserted into the fastening member 40A, and moved outwardly by a compression spring 50A-1, and a plurality of tight contact elements 60A provided on the compression member 50A tightly clamped on the outer peripheral surface of the pipe when the compression member 50A is moved.

The inner peripheral surface of the first body member 10A has a size for receiving the pipe 1, in which the first body member 10A includes, on each of left and right sides of the inner peripheral surface with reference to the longitudinal center of the inner peripheral surface, a stepped portion 10A-1, a first insertion groove 10A-2 formed vertically in relation to the stepped portion 10A-1, and a threaded portion 10A-3 formed to horizontally extend from the first insertion groove 10A-2, wherein the stepped portion 10A-1, the first insertion groove 10A-2 and the threaded portion 10A-3 are arranged in this order from the longitudinal center to each end of inner peripheral surface of the first body member 10A. Through this construction, the first body member 10A may receive or engage with the first fluid-tight member 20A, the support member 30A, the fastening member 40A, the compression members 50A, and the tight contact element 60A which are provided sequentially in each of the left and right sides of the inner peripheral surface thereof with reference to the longitudinal center of the inner peripheral surface, whereby the first body member 10A may connect two pipes 1, wherein the components will be described in detail below.

The first body member 10A may take any of an elbow shape, a T shape, a branched shape (for allowing additional installation of pipes to the opposite lateral sides of a linear shape), etc. for diverting pipe-connecting directions besides a linear shape as shown in the drawings.

The first fluid-tight member 20A is a kind of packing formed from a rubber material, in which the first fluid-tight member 20A includes a compression ring portion 20A-1 arranged along the first insertion groove 10A-2; a seating portion 20A-2 integrally extending from the compression ring portion 20A-1 and arranged on the stepped portion 10A-1; and an elastic portion 20A-3 slantingly extending from an end of the seating portion 20A-2 toward the center of the first body member 10A to come into tight contact with the pipe 1 along the outer peripheral surface of the pipe 1. When the pipe 1 is inserted, the elastic portion 20A-3 is deformed in the same direction by coming into tight contact with the pipe 1, and when fluid pressure is applied in the direction for disengaging the pipe 1, the elastic portion 20A-2 serves to prevent fluid-leakage, thereby ensuring fluid-tightness at a pipe-to-pipe connection part for fluid conveyance.

The support member 30A is formed from a synthetic resin material or a metallic material, and has a ring shape formed with a compression groove 30A-1 that comes into tight contact with the compression ring portion 20A-1. With this construction, when the first body member 10A and the fastening member 40A are engaged with each other, the compression ring portion 20A-1 comes into tight contact with the compression groove 30A-1, thereby preventing minute leakage from occurring in a gap between the stepped portion 10A-1 and the seating portion 20A-2. In addition, when the first body member 10A and the fastening member 40A are engaged with each other, the support member 30A can firmly compress the first fluid-tight member 20A in a linear direction thereby preventing the first fluid-tight member 20A from being physically damaged by a frictional force that may be applied to the first fluid-tight member 20A due to the rotation of the end of the fastening member 40A.

The fastening member 40A is adapted to compress the support member 30A by one end thereof by being screwed to the first body member 10A, in which the fastening member 40A has a slanted surface 40A-1 with an inner diameter increasing along the direction of inserting the pipe 1, and a stopper portion 40A-2 formed at the smallest-diameter end of the slanted surface.

With this construction, the fastening member 40A prevents the first fluid-tight member 20A and the support member 30A from being disengaged from the body member 10A, and enables one-touch connection of the pipe 1 in cooperation with the compressing member 50A and the tight contact elements 60A, in which the stopper portion 40A-2 is positioned following the smallest-diameter portion of the slanted surface 40A-1.

The compression member 50A is formed in a perforated shape to allow the pipe 1 to be inserted into the fastening member 40A, in which the compression member 50A has a first protrusion rib 50A-2 inserted into the fastening member 40A to form a closed space for arranging a compression spring 50A-1 together with the stopper portion 40A-2, and a second protrusion rib 50A-3 formed opposite to the first protrusion rib 50A-2 and exposed to the outside. The compression member 50A is inserted into the fastening member 40A, and the second protrusion rib 50A-3 is provided and allows the entirety of the compression member 50A to be easily pushed or pulled for assembling or disassembling the compression member 50A.

The tight contact elements 60A are installed at regular intervals on the compression member 50A positioned on the slanted surface 40A-1, in which the tight contact elements 60A have a teeth 60A-1. As a result, when the pipe 1 is inserted into the first body member 10A, the teeth 60A-1 comes into tight contact with the outer peripheral surface of the pipe 1 with the help of the restoring force of the compression spring 50A-1.

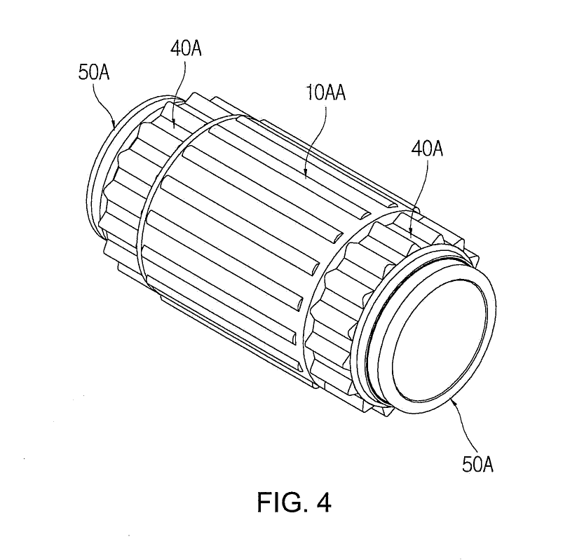

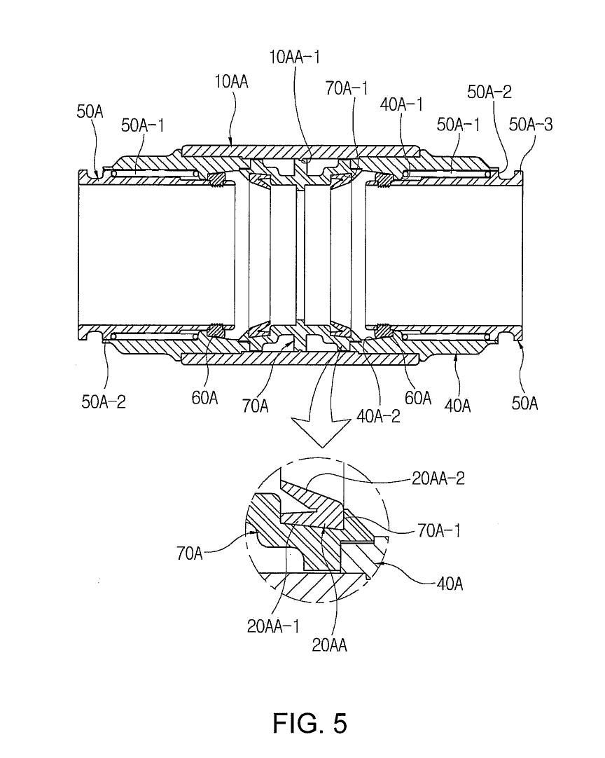

FIGS. 4 and 5 show a one-touch pipe connection device, according to another embodiment of the invention.

The one-touch pipe connection device includes a second body member 10AA, into which two pipes 1 are inserted, an insertion member 70A fixed to the second body member 10AA at the inner longitudinal center of the second body member 10AA, a pair of fluid-tight members 20AA arranged to be engaged with the opposite sides of the inner peripheral surface to ensure fluid-tightness, a pair of fastening member 40A screwed to the second body member 10AA to support the opposite sides of the insertion member 70A, a pair of compression members 50A inserted into the fastening members 40A, respectively, and each of the compression members being adapted to be moved outwardly by a compression spring 50A-1, and a plurality of tight contact elements 60A provided on each of the compression members 50A and coming into tight contact with the pipes 1 when the compression members 50A are moved outwardly.

The second body member 10AA has an inner peripheral surface with a size for receiving the pipes 1, and an anchoring protrusion 10AA-1 formed along the center of the inner peripheral surface, the inner peripheral surface being formed with threads on the opposite end areas thereof. This construction makes it easy to fabricate the second body member 10AA with a simple shape, and makes it possible for the second fluid-tight members 20AA to be fixedly fitted in the second body member 10AA, by assembling the insertion member 70A with the second body member 10AA through the anchoring protrusion 10AA-1.

Here, it may be sufficient if the anchoring protrusion 10AA-1 has a size allowing the clamping or escaping of the insertion member 70A in order for the insertion member 70A to be arranged at the center of the second body member 10AA.

The insertion member 70A is inserted into the second body member 10AA and fixed along the stopping protrusion 10AA-1 at the central area thereof, and the insertion member 70A has a pair of second insertion grooves 70A-1 which are formed at the opposite sides of the inner peripheral surface of the insertion member 70A, respectively, so that the second fluid-tight members 20AA are fixed along the insertion grooves 20AA, respectively. The insertion member 70A is fixed in a state in which the insertion member 70A cannot be moved within the inside of the second body member 10AA by the fastening members 40A coupled to the second body member 10AA, and no physical force, such as frictional force, can be transferred to the second fluid-tight members 20AA, thereby preventing the damage of the second fluid-tight members 20AA.

The second fluid-tight members 20aa are a kind of packing formed from a rubber material, in which each of the second fluid-tight members 20AA includes a fixed portion 20AA-1 fixedly fitted in one of the second insertion grooves 70A-1, and an elastic portion 20AA-2 slantingly extending from the end of the fixed protrusion 20AA-1 toward the longitudinal center of the second body member 10AA to come into tight contact with the pipe 1 along the outer peripheral surface of the pipe 1. When the pipe 1 is inserted, each of the elastic portions 20A-3 is bent in the same direction by coming into tight contact with the pipe 1, and when fluid pressure is applied in the direction for disengaging the pipe 1, each of the elastic portions 20A-2 serves to prevent fluid-leakage, thereby ensuring fluid-tightness at a pipe-to-pipe connection part for fluid conveyance.

The fastening members 40A are adapted to compress the insertion member 70A by the ends thereof by being screwed to the second body member 10AA, in which each of the fastening member 40A has a slanted surface 40A-1 with an inner diameter increasing along the direction of inserting the pipe 1, and a stopper portion 40A-2 formed at an end of the slanted surface. Because the fastening members 40A, the compression members 50A and the tight contact elements 60A are similar to or the same with those of the previously described embodiment in terms of construction and function, the detailed descriptions will be omitted.

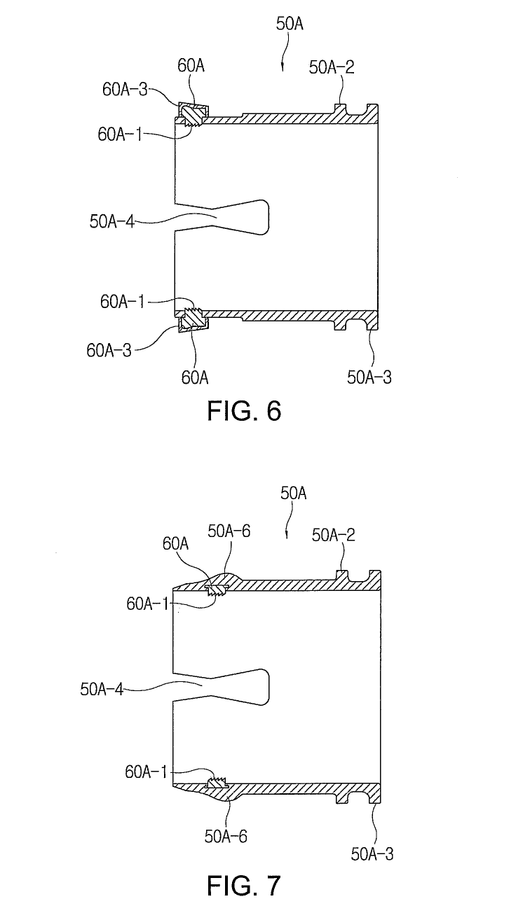

Now, methods of installing the tight contact elements 60A will be described with reference to FIGS. 6 and 7. FIGS. 6 and 7 are cross-sectional views showing engagement constructions between a compression member and tight contact elements in a one-touch pipe connection device, according to an embodiment of the invention. Insertion holes 50A-5 for fixedly inserting the tight contact elements 60A are formed in each of the compression members 50A, and then the tight contact elements 60A are inserted into the insertion holes 50A-5, respectively, in which each of the tight contact elements 60A is provided with a protrusion piece 60A-2 which is supported by the corresponding slanted surface 40A-1 to make the teeth 60A-1 comes into tight contact with the outer peripheral surface of a pipe 1 with the help of the restoring force of the corresponding compression spring 50A-1 when the pipe 1 is inserted. Here, it is desirable to design the length and shape of the tight contact elements 60A in consideration of the insertion holes 50A-5 in such a manner that the tight contact elements can be fixedly fitted in the insertion holes 50A-5 only when each of the tight contact elements 60A is inserted into one of the insertion holes 50A-5 in a predetermined direction. This is desirable in order to prevent the orientation of the teeth 60A-1 from being reversed in the process of assembling the tight contact elements because the orientation of the teeth 60A-1 may be reversed in correspondence to the installing direction of each of the tight contact elements 60A when the teeth 60A-1 of the tight contact elements 60A are adapted to be inclined in the direction of inserting the pipe 1 to make the teeth 60A-1 comes into contact with the pipe 1 more preferably.

For reference, a method of inserting the tight contact elements 60A into the insertion holes 50A-5 of each of the compression members 50A is conducted as follows. An external force is applied, toward the internal longitudinal center, to a part of the end of the compression member 50A inserted into the first body member 10A or the second body member 10AA by using a tool, so that the insertion hole-formed area is bent, in which state each of the tight contact elements 60A is inserted into one of the insertion holes 50A-5 through a spaced gap formed by bending the insertion hole-formed area, thereby allowing the tight contact element 60A to be moved only within a space formed between the slanted surface 40A-1 and the pipe 1 from the stopper portion 40A-2. In order to install the tight contact elements 60A in this manner, the insertion hole-formed area in each of the compression members 50A should have a proper elastic flexibility. Therefore, if the compression members 50A are formed from a metallic material or a synthetic resin material, the size of each of the compression members 50A should be properly determined so that the insertion hole-formed areas have a proper elastic flexibility to allow the areas to be returned to the original states thereof after they are inwardly bent.

Another method of installing the tight contact elements 60A is conducted as follows. Each of the compression members 50A is formed with a plurality of slits 50A-4, which are spaced apart from each other and extend longitudinally from the end opposite to the second protrusion rib 50A-3, and makes the slit-formed area have an elastic flexibility. As a result, each of the compression members 50 may be partially bent to make the contact members 60A be capable of being positioned on the corresponding slanted surface 40A-1, even when each of the compression members 50A is inserted into the first body member 10A or second body member 10AA to make the tight contact elements 60 comes into contact with the corresponding stopper portion 40A-1 in a state in which the tight contact elements 60A are fixedly fitted in the compression member 50A in advance, whereby it is possible to solve the problem of complexity in installing the tight contact elements 60A in the above-mentioned installation method.

In addition, an annular rubber band 60A-3 may be additionally provided and entirely surround the tight contact elements 60A fitted in each of the compression members 50A to prevent the tight contact elements 60A from escaping from the insertion holes 50A-5. As such, the rubber band 60A-3 is capable of clamping the tight contact elements 60A by its elastic force, and is variable in size in cooperation with the slit-formed area of the corresponding compression member 50A.

In consideration of the method of installing the tight contact elements 60a in each of the compression members 50A, it is possible to make the tight members 60A be partially embedded in each of the compression members 50A at the time of an injection-molding of the corresponding compression member 50A, and to form convex portions 50A-6 that are supported by the corresponding slanted surface 40A-1 to allow the teeth 60A-1 of the tight contact elements 60A, which are partially embedded in the corresponding compression member 50A, to come into tight contact with the pipe 1, i.e. to provide convex portions 50A-6 conducting the same function with the protrusion pieces 60A-2 on the compression members 50A, whereby the step of fitting the tight contact elements 60a in the insertion holes 50A-5 can also be omitted.

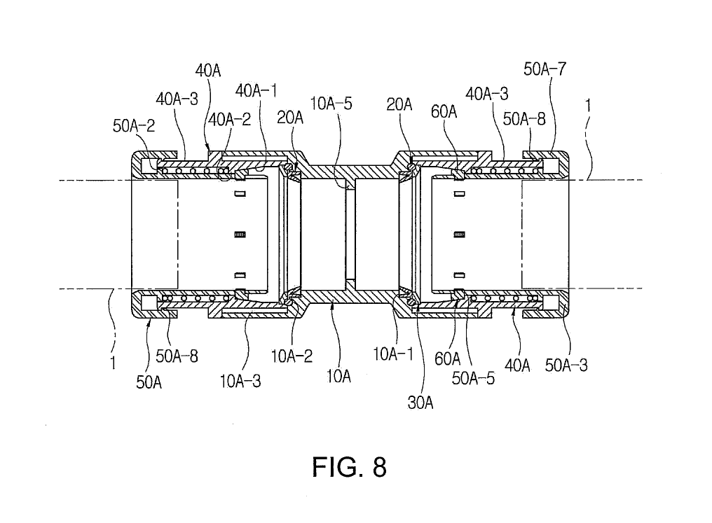

FIG. 8 shows a construction in which a cover part is applied to the one-touch pipe connection device, according to an embodiment of the invention. In order to prevent subsequent maintenance and repair works from being difficult as a foreign matter is introduced into the gaps between the fastening members 40A and the compression members 50A when the one-touch pipe connection device is embedded underground or into a wall, the one-touch pipe connection device may further include cover parts 50A-7, each of which extends from the end portion of one of the second protrusion ribs 50A-3 to cover the corresponding fastening member 40A along the circumference of the end portion as shown in FIG. 8.

By forming one or more escape prevention protrusions 50A-8 on the inner peripheral surface of each of the cover parts 50A-7, and forming a recessed portion 40A-3 on the outer peripheral surface of each of the fastening members 40A to allow the corresponding compression member 50A to be moved within a predetermined extent by forcedly fitting the escape prevention protrusions 50A-8 on the recessed portion, it is possible to prevent the disengagement of the one-touch pipe connection device. Alternatively, such escape prevention construction by the escape prevention protrusions 50A-8 and the recessed portion 40A-3 may be applied to the end portion of each of the first protrusion rives 50A-2 and the inner peripheral surface of each of the fastening members 40A.

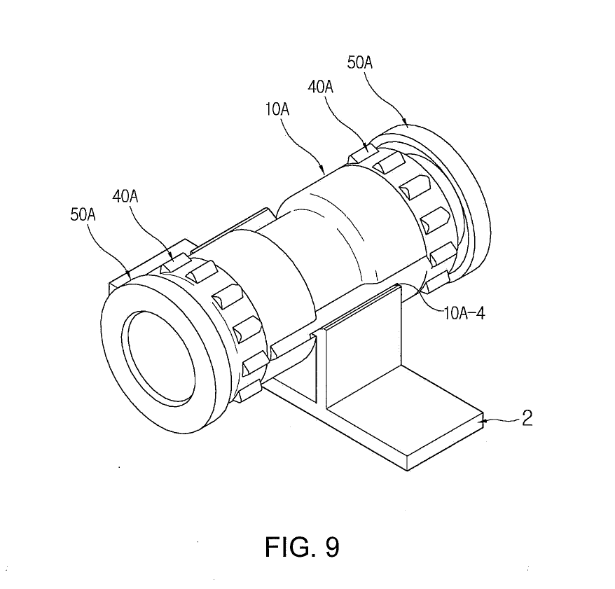

FIG. 9 shows a construction for fixing the one-touch pipe connection device to an elastic bracket, according to an embodiment of the invention. Referring to FIG. 9, to make the connection device capable of being maintained in a state of being strongly fixed to a conventional elastic bracket 2 anchored to a wall or a floor to anchor a cylindrical member, one or more anchoring ribs 10A-4 may be formed on the outer peripheral surface of at least one of the first body member 10A and the fastening member 40A, in such a manner that one or more end portions of the elastic bracket 2 can be engaged with and anchored to the anchoring ribs 10A-4, in which the anchoring ribs 10A-4 may be preferably provided with openings or grooves for anchoring the end portions of the elastic bracket 2.

In addition, the first body member 10A is provided with an insertion-limiting rib 10A-5 on the inner peripheral surface thereof having a linearly extending area to allow the pipes 1 to be inserted into the first body member 10A by the same length from each end of the first body member 10A. As a result, the pipes oppositely arranged in the first body member 10A may remain in the equally anchored state.

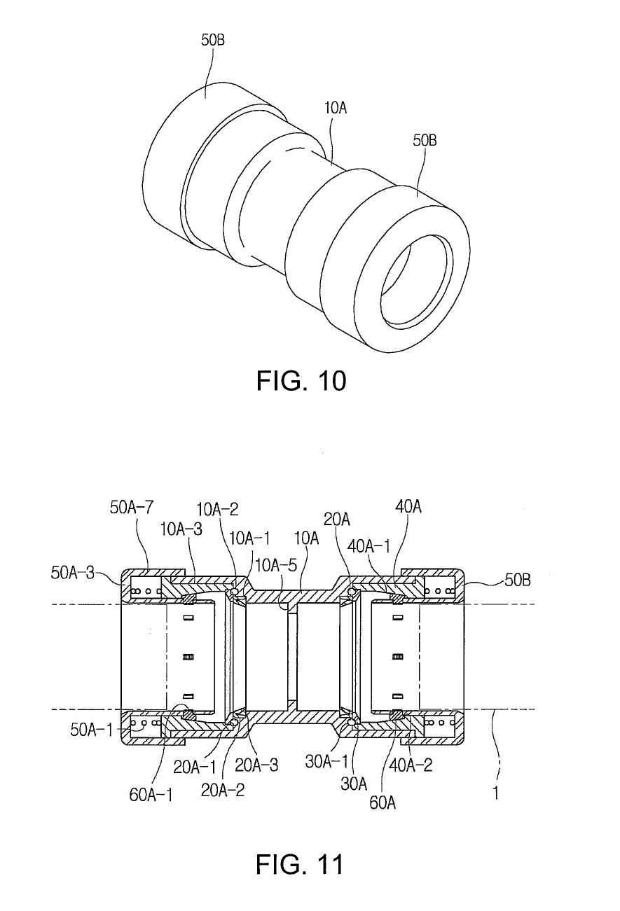

FIG. 10 shows a one-touch pipe connection device, according to an embodiment of the invention. The one-touch pipe connection device includes a first body member 10A for receiving pipes 1, a pair of first fluid-tight members 20A oppositely arranged in the first body member 10A with reference to the central part of the first body member 10A to ensure fluid-tightness, a pair of support members 30A for linearly compressing the first fluid-tight members 20A, respectively, a pair of fastening members, each of which is screwed to the first body member 10A; a pair of push members 50B inserted into the fastening members 40A, respectively, each of the push members 50B being outwardly moved by a compression spring 50A-1, and a pair of tight contact elements 60A provided on the push members 50B to come into tight contact with the push members 50B when the push members 50B are moved.

The first body member 10A has a size to receive the pipes 1, in which the first body member 10A includes, on each longitudinal half of the inner peripheral surface in order from the central part to each end of the body member, a stepped portion 10A-1, a first insertion groove 10A-2 formed vertically in relation to the stepped portion 10A-1, and a threaded portion 10A-3 formed to horizontally extend from the first insertion groove 10A-2. With this construction, the first body member 10A receives or engages with the first fluid-tight members 20A, the support members 30A, the fastening members 40A, the push members 50B and the tight contact elements 60A to interconnect two pipes 1, in which the components will be described in detail below.

For changing the interconnecting direction of the pipes 1, the first body member 10A may be formed in an elbow shape, a T shape, a branched shape (that allows a plurality of pipes to be additionally installed to the opposite sides of a linearly shaped body member), or the like in addition to the linear shape.

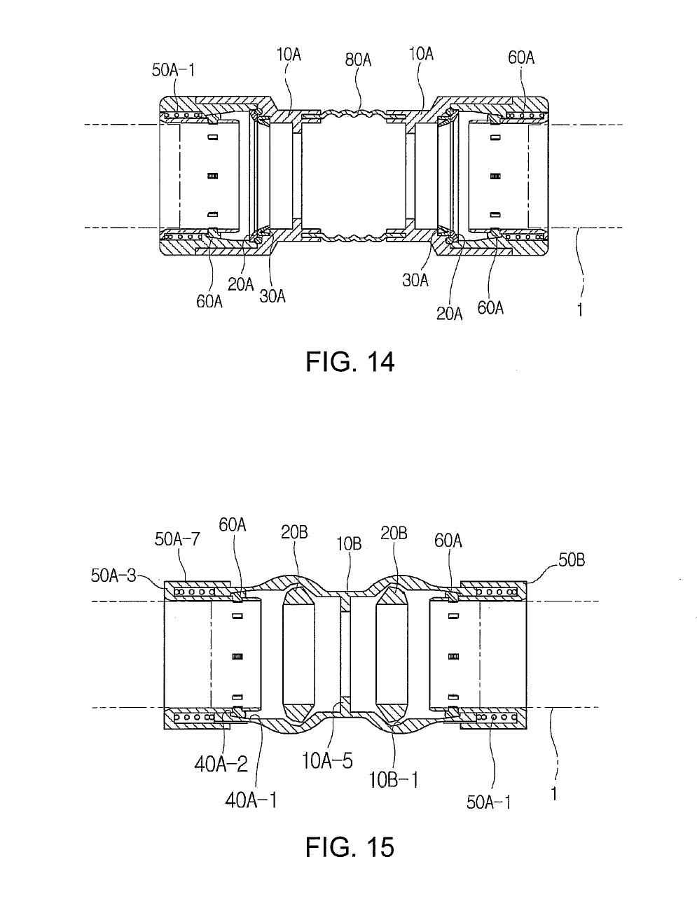

In addition, as shown in FIG. 14, the linear shaped first body member 10A may be divided into two halves with reference to its central part, and the divided halves of the first body member 10A may be interconnected by a corrugated tube 80A, the opposite ends of which are embedded, through an insert-molding process, in the divided halves of the first body member 10A, respectively. With this construction, it is possible to provide a pipe which is very convenient to change the interconnecting direction of the pipe 1. Here, in order to prevent the corrugated tube 80A from escaping from the halves after the insert-molding process, it is desirable to form openings or uneven portions on the parts of the corrugated tubes to be embedded in the halves. Since the construction of the corrugated tube 80A is known in the art, the detailed description thereof will be omitted.

Each of the first fluid-tight members 20A is a rubber packing including a compression ring portion 20A-1 arranged along the corresponding first insertion groove 10A-2, a seating portion 20A-2 integrally extending from the corresponding compression ring portion 20A-1 and arranged on the corresponding stepped portion 10A-1, and an elastic portion 20A-3 slantingly extending from an end of the seating portion 20A-2 toward the central part of the first body member 10A to come into tight contact with the pipe 1 along the outer peripheral surface of the corresponding pipe 1. With this construction, when the pipe 1 is inserted, the elastic portion 20A-3 is bent in the same direction as the pipe 1 by coming into close contact with the pipe 1, and when a fluid pressure is applied to the pipe 1 in the direction of disengaging the pipe 1, the elastic portion 20A-3 functions to prevent the leakage of fluid, thereby ensuring fluid-tightness at the pipe-to-pipe connection part for conveying fluid.

For reference, the first fluid-tight members 20A may be additionally compressed by the support members 30A after being anchored to the first body member 10A. Each of the support members 30A is formed in a ring shape from a plastic or metallic material to have a compression groove 30A-1 that comes into tight contact with the compression ring portion 20A-1 of the corresponding first fluid-tight member 20A. With this construction, the compression ring portions 20A-1 come into tight contact with the compression grooves 30A-1, respectively when the first body member 10A and the fastening members 40A are engaged with each other, thereby preventing even tiny leakage from occurring at the gaps formed between the stepped portions 10A-1 and the seating portions 20A-2. In addition, each of the first fluid-tight members 20A can be compressed merely in a linear direction to prevent the first fluid-tight members 20 from being physically damaged by a frictional force that may be applied to each of the first fluid-tight members 20A if the ends of the fastening members 40A are rotated when the first body member 10A and the fastening members 40A are engaged with each other.

Each of the fastening members 40A is adapted to compress the corresponding support member 30A by one end thereof by being screwed to the first body member 10A, in which each fastening member 40A has a slanted surface 40A-1 with an inner diameter increasing along the direction of inserting the corresponding pipe 1, and a stopper portion 40A-2 formed at an end of the slanted surface 40A-1.

With the above-mentioned construction, the fastening members 40A are adapted to prevent the first fluid-tight members 20A and the support members 30A from being disengaged from the first main body 10A, and enable one-touch connection of the pipes 1 in cooperation with the push members 50B and the tight contact elements 60A, in which the stopper portions 40A-2 are positioned at the smallest diameter portions of the slanted surfaces 40A-1, respectively.

FIGS. 11 to 14 show examples of different modifications of a one-touch pipe connection device, according to an embodiment of the invention. FIG. 15 shows a one-touch pipe connection device, according to an embodiment of the invention and FIG. 16 shows a construction of a tight contact element clamped by a rubber band in the one-touch pipe connection device, according to an embodiment of the invention.

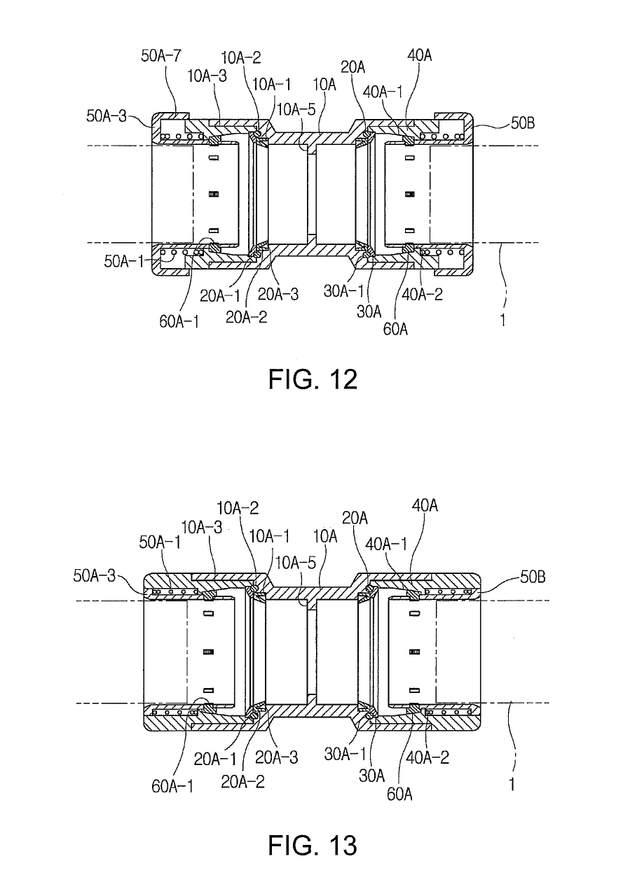

Referring to FIGS. 11 and 12, each of the push members 50B has a punched shape to receive a pipe 1, and is partially inserted into one of the fastening members 40A, in which each push member 50B has a second protrusion rib 50A-3 provided at an end of the push member 50B to be exposed to the outside to allow a compression spring 50A-1 to be arranged between the second protrusion rib 50A-3 and an end of the fastening member 40A or the stopper portion 40A-2, whereby the moving space of the push member 50B is also used as a space for arranging the compression spring 50A-1. As a result, the entire length of the one-touch pipe connection device may be reduced as compared to a construction in which the compression springs 50A-1 are positioned within the fastening members 40A. Here, the second protrusion ribs 50A-3 also serve to allow the push members 50B to be easily installed or disassembled by compressing or pulling the entirety of the push members 50B.

The tight contact elements 60A are installed at regular intervals on each of the compression members 50A positioned on the slanted surfaces 40A-1, and each of the tight contact elements 60A is provided with a teeth 60A-1. As a result, when the pipes 1 are inserted into the first body member 10A, the teeth 60A-1 comes into tight contact with the outer peripheral surfaces of the pipes 1 with the help of the restoring force of the compression springs 50A-1.

Meanwhile, another embodiment of the one-touch pipe connection device, as shown in FIG. 15, includes a body member 10B for receiving pipes 1, a pair of packing members 20B arranged to be opposite to each other with reference to the central part of the body member 10B to ensure fluid-tightness, a pair of push members 50B inserted into the body member 10B to be moved to the outside by compression springs 50A, respectively, and tight contact elements 60A installed on the push members 50B to come into contact with the outer peripheral surfaces of the pipes when the push members 50B are moved.

The body member 10B includes a pair of recessed portions 10B-1 formed by recessing the inner peripheral surface of the body member 10B, a pair of slanted surfaces 40A-1, each of which has an inner diameter increasing in the direction of inserting a pipe 1, and a pair of stopper portions 40A-2, each of which is formed at an end of the slanted surface, in which the recessed portions 10B-1, the slanted surfaces 40A-1 and the stopper portions 40A-2 are symmetrically arranged on the inner peripheral surface of the body member 10B with reference to the central part of the body member 10B in this order.

As the body member 10B takes a construction in which the first member 10A and the fastening members 40A of the previously described embodiments are integrated with each other and the recessed portions 10B-1 for installing the packing members 20B, it is possible to omit the process of assembling the first body member 10A and the fastening members 40A.

Each of the packing members 20B is an annular packing member that is inserted into the body member 10B by being deformed by an external force, and comes into tight contact with the inside of the corresponding recessed portion 10B-1. As a result, when a fluid pressure is applied to the opposite sides of the body member 10B, the packing members 20B come into tight contact with the pipes 1, thereby providing fluid-tightness.

Because the push members 50B and the tight contact elements 60A of the present invention are the same with those of the previously described embodiments, the detailed descriptions thereof will be omitted.

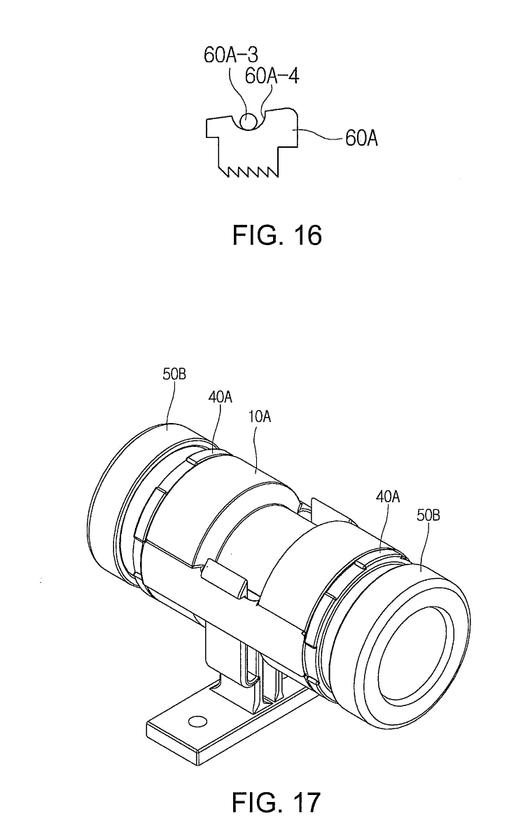

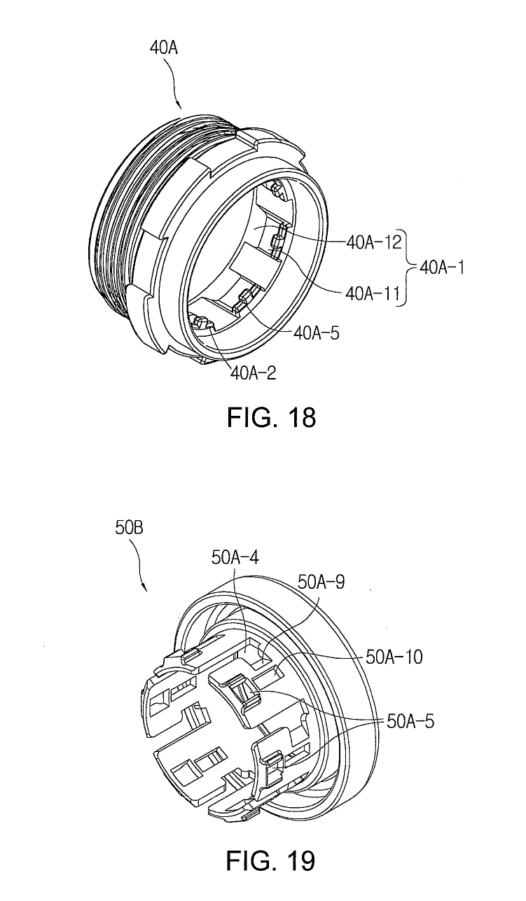

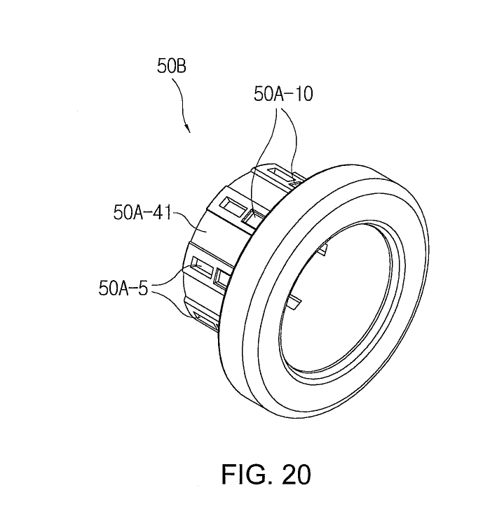

FIG. 17 illustrates a perspective view showing a construction in which a bracket is installed to a one-touch pipe connection device, according to an embodiment of the invention. FIGS. 18 to 20 show that a disengagement prevention feature is applied between a push member and a fastening member in a one-touch pipe connection device, according to an embodiment of the invention.

Referring to FIGS. 17 to 20, the first body member 10A is adapted to be fastened to a conventional bracket anchored to a wall, in which each compression member 50A of the above-described embodiments is formed with a plurality of slits 50A-4 spaced apart from each other and extending longitudinally from the end opposite to the second protrusion rib 50A-3 of the push member 50B, so that the slit-formed area of the push member 50B can be elastically deformed. This is to make the push member 50B be partially deformed to allow the tight contact elements 60A to be positioned on the corresponding slanted surface 40A-1, even if the tight contact elements 60A come into contact with the corresponding stopper portion 40A-2 when the push member 50B is pushed into the first body member 10A or the body member 60A in a state in which the tight contact elements 60A are fitted on the push members 60A in advance.

Now, a method of fitting the tight contact elements 60A will be described with reference to the drawings. A plurality of insertion holes 50A-5 are formed in each of push member 50B, in which the tight contact elements 60A are fixedly inserted into the insertion holes 50A-5 in such a manner that when a pipe 1 is inserted, the teeth 60A-1 come into tight contact with the outer peripheral surface of the pipe 1 with the help of the restoring force of the corresponding compression spring 50A-1. Here, it is desirable to design the length and shape of the tight contact elements 60A in consideration of the insertion holes 50A-5 in such a manner that the tight contact elements 60A can be fixedly fitted in the insertion holes 50A-5 only when each of the tight contact elements 60A is inserted into one of the insertion holes 50A-5 in a predetermined direction. This is desirable to prevent the orientation of the teeth 60A-1 from being reversed in the process of assembling the tight contact elements because the orientation of the teeth 60A-1 may be reversed in correspondence to the installing direction of each of the tight contact elements 60A when the teeth 60A-1 of the tight contact elements 60A are adapted to be inclined in the direction of inserting the pipe 1 to make the teeth 60A-1 come into contact with the pipe 1 more preferably.

Preferably, each of the tight contact elements 60A has a shape with a height gradually increasing in the diameter increasing direction of the slanted surface 40A-1, and the slanted surface 40A-1 includes a slowly slanted surface 40A-11 (the surface formed following the stopper portion 40A-2) that allows each of the tight contact elements 60A to come into tight contact with the pipe 1, and a rapidly slanted surface 40A-12 for providing a space that allows the teeth 60A-1 of the tight contact elements 60A to be pivoted to the outside of insertion holes 50A-5 so that the teeth 60A-1 do not come into tight contact with the pipe 1. With this construction, when the push member 50B is pressed toward the first body member 10A, the teeth 60A-1 of the tight contact elements 60A are positioned in the space between the rapidly slanted surface 40A-12 and the pipe 1, thereby allowing the pipe 1 to be disengaged. To the contrary, when the push member 50B is moved to the outside, the protrusion pieces 60A-2 of the tight contact elements 60 are press-fitted between the slowly slanted surface 40A-11 and the pipe 1, thereby preventing the pipe 1 from being disengaged.

In order to minimize the escaping of the tight contact elements from the insertion holes 50A-5, the surrounding part of the insertion holes 50A-5 of each push member 50B may be reinforced to such an extent that the surrounding parts do not exceed the height of the protrusion pieces 60A-2 to increase the contact area between the tight contact elements 60A and the insertion holes 50A-5. As shown in FIG. 16, each of the protrusion pieces 60A-2 may be formed with a seating groove 60A-4, and the tight contact elements 60A fitted in a circular arrangement on the push member 50B may be fixed by an annular rubber band 60A-3 installed along the seating grooves 60A-4 of the protrusion pieces 60A-2, in which the rubber band 60A-3 is variable in size together with the slit-formed area, so that the rubber band 60A-3 does not hinder the contact of the tight contact elements 60A to the corresponding slanted surface 40A-1.

In addition, in order to prevent subsequent maintenance and repair works from becoming difficult when foreign matter is introduced into the gaps between the fastening members 40A and the compression members 50A when the one-touch pipe connection device is embedded underground or into a wall, the one-touch pipe connection device may further include cover parts 50A-7, each of which extends from the end portion of one of the second protrusion ribs 50A-3 to cover the corresponding fastening member 40A along the circumference of the end portion as shown in FIGS. 8, 11, 12, and 15.

Moreover, by forming one or more escape prevention protrusions 50A-8 on the inner peripheral surface of each of the cover parts 50A-7, and forming a recessed portion 40A-3 on the outer peripheral surface of each of the fastening members 40A to allow the corresponding compression member 50A to be moved within a predetermined extent by forcedly fitting the escape prevention protrusions 50A-8 on the recessed portion, it is possible to prevent the disengagement of the one-touch pipe connection device. As another construction for preventing the push members 50B from being disengaged from the fastening members, it is possible to form a plurality of slots 50A-10 between the insertion holes 50A-5 and the second protrusion rib 50A-3 of each push member 50B, and to form a plurality of movement-limiting protrusions 40A-5 on the stopper portion 40A-2 of each fastening member 40A to be inserted into the slots 50A-10 (in the form of openings or grooves), so that when the push member 50B is partially deformed and introduced into the fastening member 40A, the movement-limiting protrusions 40A-5 can be positioned in the slots 50A-10, respectively, thereby prevent the disengagement of the push member 50B while the push member 50B is linearly moved. Here, the slots 50A-10 are preferably formed by a distance for introducing the push member 50B into the fastening member 40A toward the second protrusion rib 50A-3 of the push member 50B from the positions of the movement-limiting protrusions 40A-5.

Here, although it is possible to make the movement-limiting protrusions 40A be directly positioned in the slots 50A-10 while the push member 50B is being partially deformed and introduced into the fastening member 40A as described above, it may be somewhat complicated to make the movement-limiting protrusions 40A-5 be positioned in the slots 50A-10 simultaneously with pushing the push member 50b into the fastening member 40A. Therefore, it is possible to form a plurality of reversely slanted surfaces 40A-4 with a slanted direction opposite to that of the slanted surface 40A-1 to extend from the stopper portion 40A-2 toward the slanted surface 40A-4 to correspond one-on-one with the tight contact elements 60A, and to form a sliding surface 50A-9 inclined upwardly toward an adjacent slot 50A-10 in each of the slits 50A-4 of the push member 50A. With this construction, it is possible to make the movement-limiting protrusions 40A-5 be more easily positioned in the slots 50A-10 by inserting the tight contact elements 60A into the fastening member 40A to come into contact with the reversely slanted surface 40A-4, and then rotating the fastening member 40A or the push member when the movement-limiting protrusions 40A-5, the sliding surfaces 50A-9 and the slots 50A-10, which are arranged along the slits 50A-4, are linearly positioned.

In order to make a part of each push member 50B have elastic flexibility, the push member 50A may be provided with one or more thickness-reduced parts 50A-41 instead of the slits 50A-4. If the fastening member 40A formed with the reversely slanted surfaces 40A-4, which have a slanted direction opposite to that of the slanted surface 40A-1, which correspond one-on-one to the tight contact elements 60A fitted on the push member 50B as described above, and which extend from the stopper portion 40A-2 toward the slanted surface 40A-4, is engaged with the push member 50B with the above-mentioned thickness-reduced, it is possible to make the movement-limiting protrusions 40A-5 be smoothly positioned in the slots 50A-10, respectively, without the above-mentioned sliding surfaces 50A-9, by rotating the fastening member 50A or the push member 50B.

As another method for preventing foreign matter from being interposed between the fastening member 40A and the push member 50B, it is possible to make the second protrusion rib 50A-3 of the push member 50B be enclosed by the fastening member 40A as shown in FIG. 13 in such a manner that the second protrusion rib 50A-3 is exposed to the outside. If the second protrusion rib 50A-3 is protected by the fastening members 40A in this manner, it is desirable to use a separate tool which can press the second protrusion rib 50A-3 from the outside when disengaging the pipe 1 from the one-touch pipe connection device.

In addition, the first body member 10A or the body member 10B may be provided with an insertion-limiting rib 10A-5 that allows pipes to be inserted by the same length from the opposite ends of the body member 10A or 10B. With this construction, the pipes 1 may be inserted into the first body member 10A or the body member 10B by a predetermined length, whereby the pipes 1 arranged in the opposite ends of the first body member 10A or the body member 10B may be anchored over the same length.

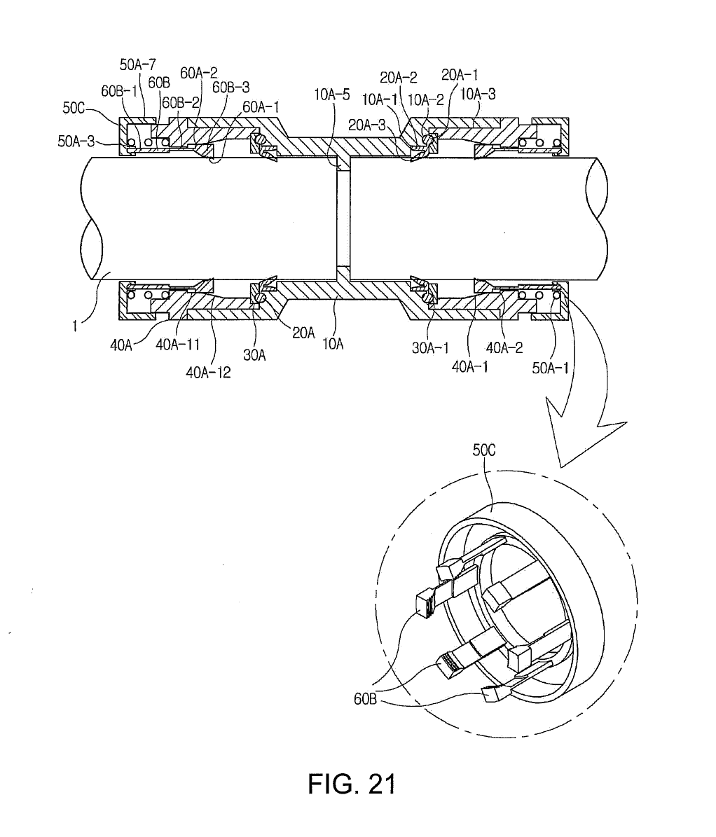

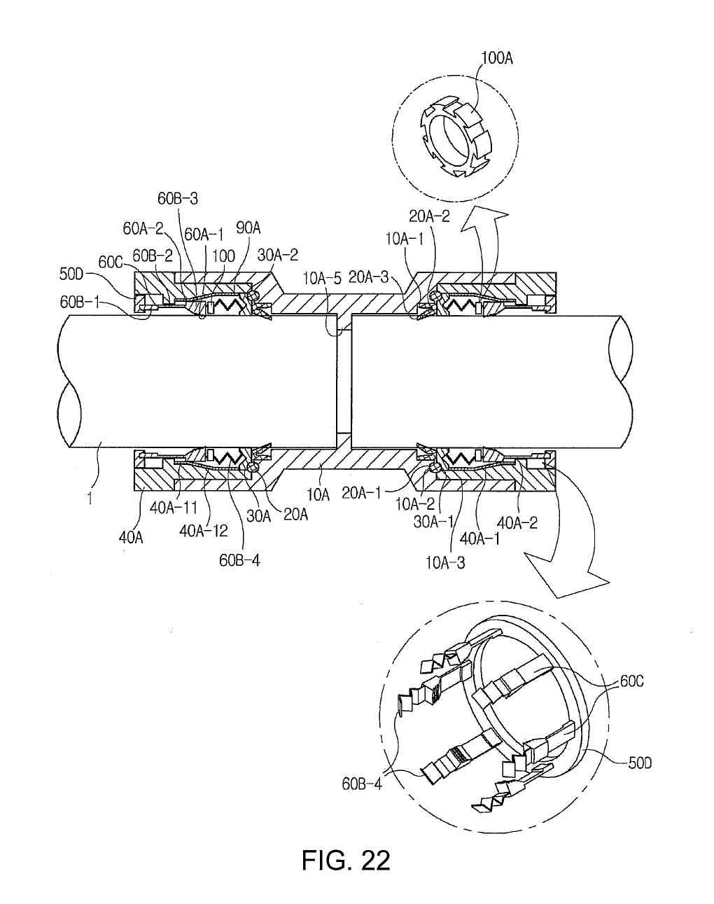

FIGS. 21 and 22 show variations of a one-touch pipe connection device, according to an embodiment of the invention. Another embodiment of the one-touch pipe connection device, as shown in FIG. 21, includes a first body member 10A for receiving pipes 1, a pair of first fluid-tight members 20A oppositely arranged with reference to the central part of the first member 10A to ensure fluid-tightness, a pair of support members 20A for linearly compressing the first fluid-tight members 20A, respectively, a pair of fastening members 40A screwed to the first body member 10A, a pair of compression members 50C inserted into the fastening members 40A, respectively, each of the compression members 50C is moved to the outside by a compression spring 50A-1, and a plurality of first clamp members 60B, each of the plurality of first clamp members 60B is fixed to the corresponding compression member 50C, so that the first clamp members 60B are tightly engaged with and clamped to the outer peripheral surface of the corresponding pipe 1 when the compression member 50C is moved.

Because the first body member 10A, the first fluid-tight members 20A, the support members 30A, and the fastening members 40A are the same with those described above, the detailed descriptions thereof will be omitted.

Each compression member 50C is centrally punched so that a pipe 1 can be inserted into the compression member 50, and the first clamp members 60B to be described in detail below are circularly arranged and fixed to the compression member 60C, so that the pipe 1 can be clamped to or separated from the first clamp members 60B, in which the compression member 50C has a second protrusion rib 50A-3 positioned in the outside to allow a compression spring to be arranged between the second protrusion rib 50A-3 and the stopper portion 40A-2 of the corresponding fastening member 40A. In addition, the compression member 50C further includes a cover part 50A-7, which extends from the outer peripheral surface of the second protrusion rib 50A-3 to cover the fastening member 40A around the end of the fastening member 40A to prevent subsequent maintenance and repair works from becoming difficult when foreign matter is introduced into a gap between the fastening member 40A and the compression members 50C when the one-touch pipe connection device is embedded underground or into a wall.

Each of the first clamp members 60B includes an extension part 60B-1, one end of the extension part 60B-1 is fixed to one side of the compression member 50C, an elastic part 60B-2 extending from the extension part 60B-1 toward a slanted surface 40A-1 formed in the fastening member 40A, and a clamp part 60B-3 having teeth 60A-1 adapted to come into tight contact with the pipe 1 and a protrusion piece 60A-2 adapted to be supported by the slanted surface 40A-1, the clamp part 60B-3 is integrally connected to the elastic part 60B-2, and the first clamp members 60B are provided in a circular arrangement to be engaged with and to clamp the pipe 1 with the help of the restoring force of the compression spring 50A-1 when the pipe 1 is inserted into the first body member 10A.

Since each of the first clamp members 60B is generally formed in a strip shape, the first clamp members 60B can be conveniently mass-produced through press processing when they are formed from a metallic material. In addition, since the first clamp members 60B make it possible to avoid a complicated process to install the clamp parts 60B-3, which practically clamp the pipe 1, on one or more separate and additional components, the productivity of the pipe connection products may be improved and the assembling process thereof can be simplified.

Here, the extension parts 60B-1 and the compression member 50C may be fixed to each other through insert molding, welding or the like, or merely by fitting the extension parts 60B-1 to the compression member 50C. Preferably, each of the elastic parts 60B-2 has a proper elastic force and size to allow the clamp parts 60B-3 to be moved in a space between the pipe 1 and the slanted surface 40A-1 in correspondence to the moving direction of the compression member 50C, so that the clamp parts 60B-3 can be engaged with or disengaged from the pipe 1.

Another embodiment of the one-touch pipe connection device according to the invention, as shown in FIG. 22, includes a first body member 10A into which two pipes are inserted, a pair of first fluid-tight members 20A arranged opposite to each other with reference to the central part of the first member 10A to ensure fluid-tightness, a pair of support members 30A for linearly compressing the fluid-tight members 20A, respectively, a pair of fastening members 40A screwed to the first body member 10A, a pair of push members 50D, each of the push members 50D is arranged inside or outside of one of the fastening members 40A to be pushed in the direction of the corresponding pipe 1, and a plurality of second clamp members 60C, each of the plurality of second clamp members 60C is fixed to the corresponding push member 50D at one end thereof when the push member 50D is moved opposite to the direction of inserting pipe 1, so that the second clamp members 60C allow the pipe 1 to be clamped or separated depending on the moving direction of the push member 50D.

Because the first body member 10A, the first fluid-tight members 20A, the support members 30A, and the fastening members 40A are the same with those of the above-mentioned embodiments, the detailed descriptions thereof will be omitted.

Each push member 50D is connected to the second clamp members 60C in such a manner that when the pipe 1 is pushed in the insertion direction by an external force, the push member 50D allows the pipe 1 to be disengaged, and is moved to the direction opposite to the pipe insertion direction by the elastic force exerted by the second clamp members 60C, in which the push member 50D and the second clamp members 60C are fixed to each other through insert-molding, welding, fitting or the like.

Each of the second clamp members 60C includes an extension part 60B-1, one end of the extension part 60B-1 is fixed to one side of the compression member 50C, the extension part extends toward the corresponding fastening member 40A, an elastic part 60B-2 extending from the extension part 60B-1 toward a slanted surface 40A-1 formed in the fastening member 40A, a clamp part 60B-3 having a teeth 60A-1 that comes into tight contact with the pipe 1 and a protrusion piece 60A-2 supported by the slanted surface 40A-1, the clamp part 60B-3 is integrally connected to the elastic part 60B-2, and a spring part 60B-4 extending from the clamp part 60B-3 to come into contact with the corresponding support member 30A, the second clamp members 60C are provided in plural pairs, the second clamp members in each pair being diametrically opposite to each other, so that they can clamp the pipe 1 with the help of the restoring force of the corresponding compression spring 50A-1 when the pipe 1 is inserted into the corresponding first body member 10A.

In addition to the second clamp members 60C being arranged similarly to the first clamp members 60B to clamp or disengage the pipe 1, the spring parts 60B-4 integrally provided in the second clamp members 60C may sub for the role of each of the compression spring 50A, thereby simplifying an assembly process. Although each spring part 60B-4 may be formed in a coil form and connected to a clamp part 60B-3 through a separate process, it is preferred to form each clamp member 60C through primary press-processing and then to form the spring part 60B-3 in the form of a leaf spring through secondary press-processing of the clamp member 60C.

Because the second clamp members 60C also have elastic flexibility in the elastic parts 60B-2 like the first clamp members 60B, the clamp members 60C are pushed toward the first body member 10A in a state in which they are in close contact with a pipe 1 when the pipe 1 is inserted, and then the close contact extent of the clamp members 60C is reduced as they approach to the largest diameter area of the slanted surface 40A-1 in the corresponding fastening member 40A, thereby allowing the pipe 1 to be inserted to the first body member 10A. In addition, after the pipe 1 is inserted, the second clamp members 60C come into firmly tight contact with the pipe 1 as they are moved toward the smallest diameter area of the slanted surface 40A-1 by the spring parts 60B-4, thereby clamping the pipe 1.

In addition, a plurality of guide grooves, into which the spring parts 60B-4 are partially inserted, respectively, are formed on each of the support members 30A, so that the elastic force applied by the spring parts 60B-4 is provided in conformity with the direction the second clamp members 60C should be moved.

If each of the fastening members 40A is formed from a synthetic resin in the present embodiment, the protrusion pieces 60A-2 may damage the slanted surfaces 40A-1 in the fastening members 40A due to the characteristics of material of the fastening members 40A when the clamp parts 60B-3 and the pipes 1 are to be pushed to the outside by a high fluid pressure. To solve this problem, a metallic member 90A in a shape of a top and bottom opened cup may be inserted into each fastening member 40A to be in tight contact with the slanted surface 40A-1 in the fastening member 40A to support the protrusion pieces 40A-2.

In addition, by providing a shape-maintaining member 100A for maintaining the circular arrangement of the second clamp members 60C to surround the area between the clamp parts 60B-3 and the spring parts 60B-4, it is possible to prevent the clamp parts 60B-3 from being arranged at irregular intervals and to prevent the spring parts 60B-4 from being bent in any direction.

For reference, each of the clamp parts 60B-3 has a shape with a height gradually increasing as approaching to the diameter-increasing slanted surface 40A-1 in a corresponding fastening member 40A, and the slanted surface 40A-1 includes a slowly slanted surface 40A-11 (the surface formed following the stopper portion 40A-2) that allows each of the protrusion pieces 60A-2 to be partially interposed between the fastening member 40A and the pipe 1, and a rapidly slanted surface 40A-12 for providing a space that allows the teeth 60A-1 of the clamp parts 60B-3 60A to be moved to the slanted surface 40-1 so that the teeth 60A-1 does not come into tight contact with the pipe 1. With this construction, when the compression member 50C or push member 50D is pressed toward the first body member 10A, the teeth 60A-1 of the clamp parts 60B-3 are positioned in the space between the rapidly slanted surface 40A-12 and the pipe 1, thereby allowing the pipe 1 to be disengaged. To the contrary, when the compression member 50C or the push member 50D is moved to the outside by an elastic force, the protrusion pieces 60A-2 of the clamp parts 60B-3 are press-fitted between the slowly slanted surface 40A-11 and the pipe 1 so that the teeth 60A-1 will compress the pipe 1, thereby preventing the pipe 1 from being disengaged.

As described above, the one-touch pipe connection device makes it possible to firmly interconnect pipes merely by inserting the pipes into the one-touch pipe connection device while providing more excellent fluid-tightness and reducing the size of the final products as compared to the prior arts. As a result, the one-touch pipe connection device may drastically shorten the periods of piping and pipe connection work, and piping maintenance and repair work, and may prevent leakage occurrence accidents in advance, and may miniaturize the final products.

In addition, because it is possible to use a synthetic resin as the material for the components of the one-touch pipe connection device beyond metallic materials due to the injection-moldable construction of each of the components, the one-touch pipe connection device may be mass-produced with low manufacturing costs.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A one-touch pipe connection device comprising:
a first body member with a size for receiving a pipe, the first body member comprising, on each of left and right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the first insertion groove, wherein the stepped portion, the first insertion groove and the threaded portion are arranged in this order from the longitudinal center to each end of inner peripheral surface of the first body member;
a first fluid-tight member comprising a compression ring portion arranged along the first insertion groove, a sealing portion integrally extending from the compression ring portion and arranged in the stepped portion, and an elastic portion slantingly extending from an end of the seating portion toward the center of the first body member so that the elastic portion comes into tight contact with the pipe along the outer peripheral surface of the pipe when the pipe is inserted;
an annular support member formed with a compression groove that comes into tight contact with the compression ring portion;
a fastening member which is configured to compress the annular support member by one end thereof by being screwed to the first body member, the fastening member having a slanted surface with an inner diameter increasing along the direction of inserting the pipe, and a stopper portion formed at the smaller-diameter end of the slanted surface;
a compression member comprising a first protrusion rib inserted into the fastening member to form a closed space for arranging a compression spring with the stopper portion, and a second protrusion rib formed opposite to the first protrusion rib and exposed to the outside; and
a plurality of tight contact elements installed at regular intervals on an end portion of the compression member positioned within the slanted surface, each of the tight contact elements having a teeth, wherein, when the pipe is inserted into the first body member, the teeth comes into tight contact with the outer peripheral surface of the pipe with a help of a restoring force of the compression spring.

2. A one-touch pipe connection device comprising:
a second body member with a size for receiving a pipe, the second body member having an anchoring protrusion formed along the inner peripheral surface of the second body member at the longitudinal center of the second body member, the inner peripheral surface being formed with threads on each end area thereof;
an insertion member inserted into the second body member and fixed along the anchoring protrusion at the longitudinal central area thereof, the insertion member having a second insertion groove at each end of the inner peripheral surface thereof;
a second fluid-tight member, the second fluid-tight member comprising a fixed ring portion fixedly fitted in the second insertion groove, and an elastic portion slantingly extending from an end of the fixed ring portion toward the center of the second body member so that the elastic portion comes into tight contact with a pipe along the outer peripheral surface of the pipe when the pipe is inserted;
a fastening member configured to compress the insertion member by one end thereof by being screwed to the second body member, the fastening member having a slanted surface with an inner diameter increasing along the direction of inserting a pipe, and a stopper portion formed at the smaller-diameter end of the slanted surface;
a compression member, the compression member comprising a first protrusion rib inserted into the fastening member to form a closed space for arranging a compression spring with the stopper portion, and a second protrusion rib formed opposite to the first protrusion rib and exposed to the outside; and
a plurality of tight contact elements installed at regular intervals on an end portion of the compression member positioned within the slanted surface, each of the tight contact elements having a teeth, wherein, when the pipe is inserted into the first body member, the teeth comes into tight contact with the outer peripheral surface of the pipe with a help of a restoring force of the compression spring.

3. The one-touch pipe connection device as claimed in claim 1, wherein the compression member is formed with a plurality of slits spaced apart from each other and extending longitudinally from the end opposite to the second protrusion rib.

4. The one-touch pipe connection device as claimed in claim 3, wherein the compression member is formed with a plurality insertion holes, into which the tight contact elements are fixedly inserted, respectively, and the tight contact element is formed with a protrusion piece supported by the slanted surface in such a manner that the teeth come into tight contact with the pipe.

5. The one-touch pipe connection device as claimed in claim 4, wherein the tight contact elements are fixedly inserted into the insertion holes only when they are inserted into the insertion holes in a predetermined direction, respectively.

6. The one-touch pipe connection device as claimed in claim 4, wherein the tight contact elements inserted into the insertion holes of the compression member are supported by an annular rubber band in such a manner that they cannot escape from the insertion holes.

7. The one-touch pipe connection device as claimed in claim 3, wherein the compression member is formed with a plurality of block parts which are supported by the slanted surface in the fastening member in such a manner that the tight contact elements is partially embedded into the block parts, respectively, and the teeth come into tight contact with the pipe.

8. The one-touch pipe connection device as claimed in claim 1, further comprising a cover part which extends along the outer end of the second protrusion rib to cover the end area of the fastening member to prevent foreign matter from being introduced into a gap between the fastening member and the compression member,
wherein the cover part is provided with an escape prevention protrusion on the inner peripheral surface thereof, and the fastening member is formed with a recessed portion on the outer peripheral surface thereof, the recessed portion allowing the escape prevention protrusion to be moved within a predetermined extent in a state in which the escape prevention protrusion is fitted on the recessed portion by an external force.

9. The one-touch pipe connection device as claimed in claim 1, wherein one or more anchoring ribs are formed on the outer peripheral surface of at least one of the first body member and the fastening member, in such a manner that one or more tip end portions of an elastic bracket can be engaged with and anchor the anchoring ribs, the elastic bracket being adapted to be anchored to a wall or floor to anchor a cylindrical member.

10. The one-touch pipe connection device as claimed in claim 1, wherein the first body member is provided with an insertion-limiting rib on the inner peripheral surface thereof, the insertion-limiting rib being adapted to allow the pipe to be inserted by the same length from each end of the first body member.

11. The one-touch pipe connection device as claimed in claim 1, wherein the first body member has a shape selected among a straight shape, an elbow shape, a T shape, and a branched shape.

12. A one-touch pipe connection device comprising:
a first body member with a size for receiving a pipe, the first body member comprising, on each of left and right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the insertion groove, wherein the stepped portion, the first insertion groove and the threaded portion are arranged in this order from the longitudinal center to each end of inner peripheral surface of the first body member;
a first fluid-tight member comprising a compression ring portion arranged along the first insertion groove, a seating portion integrally extending from the compression ring portion and arranged in the stepped portion, and an elastic portion slantingly extending from an end of the seating portion toward the center of the first body member so that the elastic portion comes into tight contact with the pipe along the outer peripheral surface of the pipe when the pipe is inserted;
an annular support member formed with a compression groove that comes into tight contact with the compression ring portion;
a fastening member which is configured to compress the annular support member by one end thereof by being screwed to the first body member, the fastening member having a slanted surface with an inner diameter increasing along the direction of inserting the pipe, and a stopper portion formed at the smaller-diameter end of the slanted surface;
a push member having a second protrusion rib provided at an outer end thereof to be exposed to the outside, the push member being configured to allow a compression spring to be arranged between the second protrusion rib and an end of the fastening member or the stopper portion, and the push member being partially inserted into the fastening member; and
a plurality of tight contact elements installed at regular intervals on an end portion of the compression member positioned within the slanted surface, each of the tight contact elements having a teeth, wherein, when the pipe is inserted into the first body member, the teeth comes into tight contact with the outer peripheral surface of the pipe with a help of a restoring force of the compression spring,
wherein the push member is formed with a plurality of slits spaced apart from each other and extending longitudinally from the end opposite to the second protrusion rib.

13. A one-touch pipe connection device comprising:
a body member having an inner peripheral surface, the body member comprising, on each of left and right sides of the inner peripheral surface with reference to the longitudinal center of the inner peripheral surface, a recessed portion formed by recessing the inner peripheral surface, a slanted surface with an inner diameter increasing along the direction of inserting a pipe, and a stopper portion formed at the smaller-diameter end of the slanted surface;
an annular packing member which is introduced into the body member by being deformed by an external force, and then comes into tight contact with the inside of the recessed portion;
a push member having a second protrusion rib provided at an outer end thereof to be exposed to the outside, the push member being adapted to allow a compression spring to be arranged between the second protrusion rib and an end of the fastening member or the stopper portion, and the push member being partially inserted into the fastening member; and
a plurality of tight contact elements installed at regular intervals on an end portion of the compression member positioned within the slanted surface, each of the tight contact elements having a teeth, wherein, when the pipe is inserted into the first body member, the teeth comes into tight contact with the outer peripheral surface of the pipe with a help of a restoring force of the compression spring,
wherein the push member is formed with a plurality of slits spaced apart from each other and extending longitudinally from the end opposite to the second protrusion rib.

14. The one-touch pipe connection device as claimed in claim 12, wherein the second protrusion rib of the push member is surrounded by the fastening member in such a manner that the second protrusion rib is not exposed to the outside.

15. The one-touch pipe connection device as claimed in claim 12, the first body member is divided into two halves with reference to its longitudinal center, and the divided halves of the first body member are connected by a corrugated tube, the opposite ends of the corrugated tube being embedded in the divided halves of the first body member, respectively.

16. The one-touch pipe connection device as claimed in claim 12, wherein the push member is formed with insertion holes, into which the tight contact elements are fixedly inserted, respectively, each of the tight contact elements being provided with a protrusion piece supported by the slanted surface in such a manner that the teeth are in tight contact with the pipe, wherein each of the tight contact elements has a shape with a height gradually increasing in the diameter increasing direction of the slanted surface, and wherein the slanted surface comprises a slowly slanted surface that allows each of the tight contact elements to come into tight contact with the pipe, and a rapidly slanted surface for providing a space that allows the teeth of the tight contact elements to be pivoted to the outside of the insertion holes so that the teeth do not come into tight contact with the pipe,
wherein the protrusion piece is formed with a seating groove for fixing an annular rubber band.

17. The one-touch pipe connection device as claimed in claim 16, wherein the push member is reinforced in the parts surrounding the insertion holes to such an extent that the surrounding parts are not thicker than the height of the protrusion piece.

18. The one-touch pipe connection device as claimed in claim 16, wherein a plurality of slots are formed between the insertion holes and the second protrusion rib of the push member, and a plurality of movement-limiting protrusions are formed on the stopper portion of the fastening member to be inserted into the slots to prevent the disengagement of the push members.

19. The one-touch pipe connection device as claimed in claim 18, wherein the fastening member is formed with a plurality of reversely slanted surfaces with a slanted direction opposite to that of the slanted surface, the reversely slanted surfaces extending from the stopper portion toward the slanted surface to correspond one-on-one with the tight contact elements, and wherein each of the slits of the push member is formed with a sliding surface which is inclined upwardly toward an adjacent slot.

20. The one-touch pipe connection device as claimed in claim 18, wherein the fastening member is formed with a plurality of reversely slanted surfaces with a slanted direction opposite to that of the slanted surface, the reversely slanted surfaces extending from the stopper portion toward the slanted surface to correspond one-on-one with the tight contact elements, and wherein thickness-reduced parts are provided instead of the slits for allowing the end portion of push member to be deformed.

21. A one-touch pipe connection device comprising:
a first body member with a size for receiving a pipe, the first body member comprising, on each of left and right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the first insertion groove, wherein the stepped portion, the first insertion groove and the threaded portion are arranged in this order from the longitudinal center to each end of inner peripheral surface of the first body member;
a first fluid-tight member comprising a compression ring portion arranged along the first insertion groove, a seating portion integrally extending from the compression ring portion and arranged in the stepped portion, and an elastic portion slantingly extending from an end of the seating portion toward the center of the first body member so that the elastic portion comes into tight contact with a pipe along the outer peripheral surface of the pipe when the pipe is inserted;
an annular support member formed with a compression groove that comes into tight contact with the compression ring portion;
a fastening member which is configured to compress the annular support member by one end thereof by being screwed to the first body member, the fastening member having a slanted surface with an inner diameter increasing along the direction of inserting the pipe, and a stopper portion formed at the smaller-diameter end of the slanted surface;
a compression member having a second protrusion rib provided to be exposed to the outside, the compression member being configured to allow a compression spring to be arranged between the second protrusion rib and the stopper portion of the fastening member; and
a plurality of first clamp members, the plurality of first clamp members comprising an extension part, one end of which is fixed to one side of the compression member, an elastic part extending from the extension part toward the slanted surface, and a clamp part having a teeth configured to come into tight contact with the pipe and a protrusion piece configured to be supported by the slanted surface, the clamp part being integrally connected to the elastic part, wherein the plurality of first clamp members are provided in plural pairs, a second clamp members in each pair being diametrically opposite to each other, so that they can clamp the pipe with the help of the restoring force of the compression spring when the pipe is inserted into the first body member.

22. A one-touch pipe connection device comprising:
a first body member with a size for receiving a pipe, the first body member comprising, on each of left and right sides of the inner peripheral surface thereof with reference to the longitudinal center of the inner peripheral surface, a stepped portion formed to horizontally extend, a first insertion groove arranged vertically in relation to the stepped portion, and a threaded portion formed to horizontally extend from the first insertion groove, wherein the stepped portion, the first insertion groove and the threaded portion are arranged in this order from the longitudinal center to each end of inner peripheral surface of the first body member;
a first fluid-tight member comprising a compression ring portion arranged along the first insertion groove, a seating portion integrally extending from the compression ring portion and arranged in the stepped portion, and an elastic portion slantingly extending from an end of the seating portion toward the center of the first body member so that the elastic portion comes into tight contact with the pipe along the outer peripheral surface of the pipe when the pipe is inserted;
an annular support member formed with a compression groove that comes into tight contact with the compression ring portion;
a fastening member which is configured to compress the annular support member by one end thereof by being screwed to the first body member, the fastening member having a slanted surface with an inner diameter increasing along the direction of inserting the pipe, and a stopper portion formed at the smaller-diameter end of the slanted surface;
a push member formed in a ring-shape, the push member being arranged inside or outside of the fastening member and pushed in the direction of inserting the pipe; and
a plurality of second clamp members, wherein each of the plurality of second clamp members comprises an extension part, one end of the extension part is fixed to one side of the compression member, an elastic part extending from the extension part toward the slanted surface, and a clamp part having a teeth configured to come into tight contact with the pipe and a protrusion piece configured to be supported by the slanted surface, the clamp part being integrally connected to the elastic part, and a spring part extending from the clamp part to come into contact with the support member,
wherein the second clamp members are provided in plural pairs, the second clamp members in each pair being diametrically opposite to each other, so that they can clamp the pipe with a help of a restoring force of the compression spring when the pipe is inserted into the first body member.

23. The one-touch pipe connection device as claimed in claim 21, wherein if the fastening member is formed from a plastic material, a metallic member is inserted into the fastening member to be in tight contact with the slanted surface of the fastening member to support the protrusion piece.

24. The one-touch pipe connection device as claimed in claim 22, wherein the support member is formed with guide grooves, into which the spring parts are partially inserted, respectively.

25. The one-touch pipe connection device as claimed in claim 22, wherein a shape-maintaining member is provided between the clamp parts and the spring parts to maintain the circular arrangement of the second clamp members.

26. The one-touch pipe connection device as claimed in claim 2, wherein the compression member is formed with a plurality of slits spaced apart from each other and extending longitudinally from the end opposite to the second protrusion rib.

27. The one-touch pipe connection device as claimed in claim 26, wherein the compression member is formed with a plurality insertion holes, into which the tight contact elements are fixedly inserted, respectively, and the tight contact element is formed with a protrusion piece supported by the slanted surface in such a manner that the teeth come into tight contact with the pipe.

28. The one-touch pipe connection device as claimed in claim 27, wherein the tight contact elements are fixedly inserted into the insertion holes only when they are inserted into the insertion holes in a predetermined direction, respectively.

29. The one-touch pipe connection device as claimed in claim 27, wherein the tight contact elements inserted into the insertion holes of the compression member are supported by an annular rubber band in such a manner that they cannot escape from the insertion holes.

30. The one-touch pipe connection device as claimed in claim 26, wherein the compression member is formed with a plurality of block parts which are supported by the slanted surface in the fastening member in such a manner that the tight contact elements is partially embedded into the block parts, respectively, and the teeth come into tight contact with the pipe.

31. The one-touch pipe connection device as claimed in claim 2, further comprising a cover part which extends along the outer end of the second protrusion rib to cover the end area of the fastening member to prevent foreign matter from being introduced into a gap between the fastening member and the compression member,
wherein the cover part is provided with an escape prevention protrusion on the inner peripheral surface thereof, and the fastening member is formed with a recessed portion on the outer peripheral surface thereof, the recessed portion allowing the escape prevention protrusion to be moved within a predetermined extent in a state in which the escape prevention protrusion is fitted on the recessed portion by an external force.

32. The one-touch pipe connection device as claimed in claim 22, wherein if the fastening member is formed from a plastic material, a metallic member is inserted into the fastening member to be in tight contact with the slanted surface of the fastening member to support the protrusion piece.
